(19) United States
(12) Patent Application Publication
(10) Pub. No.: US 2024/0214407 A1
(43) Pub. Date: Jun. 27, 2024

(54) SYSTEM AND METHOD FOR IMPROVED RENDERING OF USER INTERFACE FOR CYBERSECURITY MONITORING SYSTEM

(71) Applicant: Wiz, Inc., New York, NY (US)

(72) Inventors: Matilda LIDGI, Tel Aviv (IL); Shai KEREN, Tel Aviv (IL); Raaz HERZBERG, Tel Aviv (IL); Avi Tal LICHTENSTEIN, Tel Aviv (IL); Ami LUTTWAK, Binyamina (IL); Roy REZNIK, Tel Aviv (IL)

(73) Assignee: Wiz, Inc., New York, NY (US)

(21) Appl. No.: 18/146,678

(22) Filed: Dec. 27, 2022

(51) Int. Cl. H04L 9/40

(52) U.S. Cl. CPC H04L 63/1433; H04L 63/20; G06F 2221/033

(57) ABSTRACT

A system and method for initiating a mitigation action based on active inspection of a cloud computing environment. The method includes: receiving at least one network path to access a resource deployed in the cloud computing environment, and potentially accessible from a network which is external to the cloud computing environment; actively inspecting the at least one network path to determine if the resource is accessible through the at least one network path from a network external to the cloud computing environment; generating a graphic element based on receiving a response from the resource of the active inspection of the at least one network path; generating an action graphic element associated with the response; rendering the graphic element and the action graphic element on a display; and initiating a mitigation action based on the response, in response to receiving an input based on the rendered action graphic element.

### TECHNICAL FIELD

The present disclosure relates generally to exposure detection in cloud environments, and specifically to a system for displaying active detection of exposure in cloud environments.

### BACKGROUND

External attack surface management (EASM) is a term which for a technology field and best practices which are utilized in cybersecurity to describe what vulnerabilities an organization has within their network infrastructure, which may include cloud computing environments, local network environments, and the like. For example, an organization may have a virtual private cloud (VPC) implemented in Amazon® Web Services (AWS), Microsoft® Azure, Google® Cloud Platform (GCP), and the like, which serves as a cloud computing environment. The cloud computing environment may include a plurality of workloads, such as virtual machines, container engines, serverless functions, and the like, any of which may pose a security risk, for example by having a vulnerability, allowing an attacker to infiltrate the organization's network in an unintended manner.

EASM technologies aim to discover where an organization is vulnerable, in order for a network administrator to secure the discovered vulnerabilities. For example, discovering an out-of-date operating system (OS) having a known vulnerability running on a virtual machine may require the network administrator to update the OS version, or apply a software patch, in order to address the vulnerability. This is also known as minimizing the external attack surface.

One such technology which may be deployed in order to discover the external attack surface is known is active scanning. Active scanning attempts to infiltrate a network (e.g., access resources in the above mentioned VPC). For example, by sending packets to endpoints in the network. Thus, an active scanner may attempt to access random domains, at random ports, in order to gain access to a network or to a network resource.

This method has some serious drawbacks. For example, attempting to guess random domains, random ports, and the like, creates a large volume of network traffic which the target (i.e., organization's network) must deal with. This may congest the network, and further risks malfunctions, such as a denial of service to other clients, data corruption from incompatible queries, and the like. It is often of upmost importance to an organization to keep a production environment in a fully operational state. Therefore, using an active scanner to test accessibility of an active production environment may be detrimental to this objective, since it would require devotion of substantial resources at least in terms of network bandwidth to perform such tests.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for initiating a mitigation action based on active inspection of a cloud computing environment. The method comprises: receiving at least one network path to access a resource, where the resource is a cloud entity deployed in the cloud computing environment, and potentially accessible from a network which is external to the cloud computing environment; actively inspecting the at least one network path to determine if the resource is accessible through the at least one network path from a network external to the cloud computing environment, generating a graphic element based on receiving a response from the resource of the active inspection of the at least one network path, generating an action graphic element associated with the response. The method also includes rendering the graphic element and the action graphic element on a display; and initiating a mitigation action based on the response, in response to receiving an input based on the rendered action graphic element.

Certain embodiments disclosed herein also include a non-transitory computer readable medium having stored thereon causing a processing circuitry to execute a process, the process comprising: receiving at least one network path to access a resource, where the resource is a cloud entity deployed in the cloud computing environment, and potentially accessible from a network which is external to the cloud computing environment; actively inspecting the at least one network path to determine if the resource is accessible through the at least one network path from a network external to the cloud computing environment, generating a graphic element based on receiving a response from the resource of the active inspection of the at least one network path, generating an action graphic element associated with the response. The method also includes rendering the graphic element and the action graphic element on a display; and initiating a mitigation action based on the response, in response to receiving an input based on the rendered action graphic element.

Certain embodiments disclosed herein also include a system for initiating a mitigation action based on active inspection of a cloud computing environment. The system comprises: a processing circuitry; and a memory, the memory containing instructions that, when executed by the processing circuitry, configure the system to: receive at least one network path to access a resource, where the resource is a cloud entity deployed in the cloud computing environment, and potentially accessible from a network which is external to the cloud computing environment; actively inspect the at least one network path to determine if the resource is accessible through the at least one network path from a network external to the cloud computing environment; generate a graphic element based on receiving a response from the resource of the active inspection of the at least one network path; generate an action graphic element associated with the response. The system also includes render the graphic element and the action graphic element on a display; and initiate a mitigation action based on the response, in response to receiving an input based on the rendered action graphic element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram of a computing environment connected to an inspection environment, utilized to describe an embodiment.

FIG. 2 is a diagram of a user interface, utilized to describe an embodiment.

FIG. 3A is a diagram of an electronic document for a user interface rendered on a user device, utilized to describe an embodiment.

FIG. 3B is a diagram of another portion of an electronic document for a user interface rendered on a user device, utilized to describe an embodiment.

FIG. 4 is a diagram of an electronic document for a user interface and action rendered on a user device, utilized to describe an embodiment.

FIG. 5 is a schematic diagram of an inspection controller according to an embodiment.

FIG. 6 is a flowchart of a method for performing active inspection of a cloud computing environment, implemented in accordance with an embodiment.

FIG. 7A is a flowchart depicting a method for determining reachable properties of security objects, according to an embodiment.

FIG. 7B is a flowchart depicting the analysis of a network path to determine reachable properties of objects included in the path, according to an embodiment.

FIG. 8 is a flowchart of a method for rendering a graphical user interface (GUI) for a user device based on a plurality of active inspection results, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for providing a graphical user interface to display results from active inspection of a cloud computing environment. In some embodiments, a result of an active inspection includes a web page which is generated based on a response received from a resource which is actively inspected.

Where a cloud computing environment includes hundreds, thousands, and the like, number of resources, each of which can be actively inspected by numerous network paths, the number of responses can be extremely large. Generally, it is accepted that humans respond better to visual stimuli, for example presenting a picture conveys information faster than having a human read a text describing the contents of such a picture. Therefore, one advantage of the teachings herein is presenting a system which is able to detect cybersecurity issues through active inspection, and generate an output which can be easily consumed by a human user to efficiently understand the cybersecurity threats, and therefore reduce reaction time to cybersecurity threats by providing information of the same in a more consumable fashion for human operators.

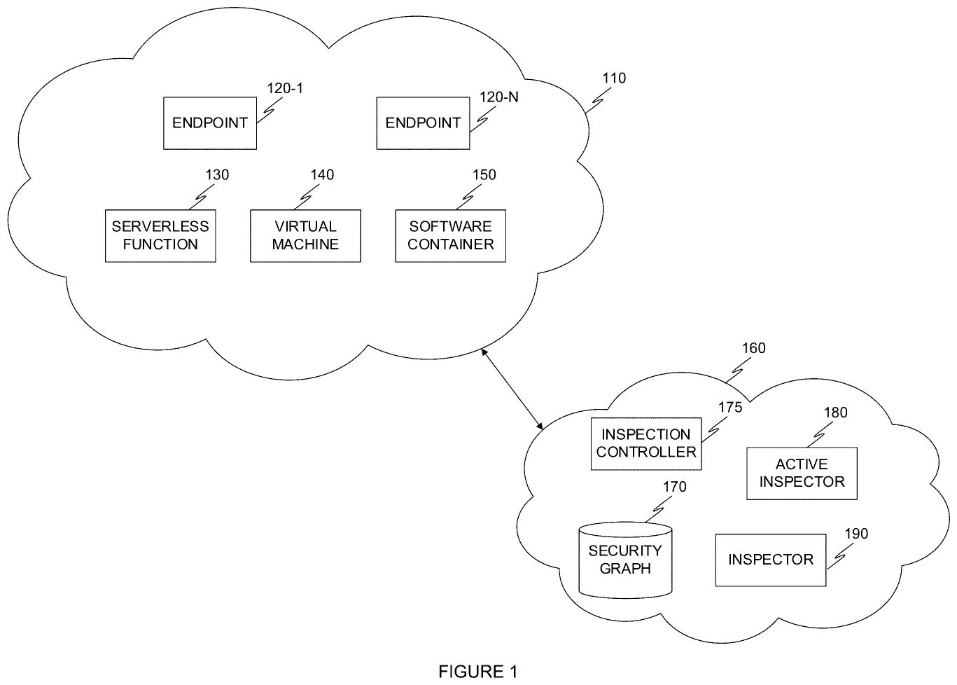

FIG. 1 is an example diagram of a computing environment connected to an inspection environment, utilized to describe an embodiment. In an embodiment, a first computing environment 110 is implemented as a cloud computing environment. A cloud computing environment is, according to an embodiment, a computing environment which is deployed on a cloud computing infrastructure. For example, a virtual private cloud (VPC) is a computing environment deployed on Amazon® Web Services (AWS), which is a cloud computing infrastructure. As another example, a Virtual Network (VNet) is a computing environment deployed on Microsoft® Azure.

In some embodiments, the computing environment 110 is a hybrid computing environment, including elements of a cloud computing environment, a network based computing environment (e.g., a local area network), and the like.

According to some embodiments, the computing environment 110 includes a plurality of endpoints 120-1 through 120-N, where ‘N’ is an integer having a value of ‘2’ or greater. The plurality of endpoints 120-1 through 120-N are referred to individually as endpoint 120 and generally as endpoints 120.

In an embodiment, an endpoint 120 is a cloud entity which is accessible to a computing environment which is not the first computing environment 110. For example, in an embodiment, an endpoint 120 is connected to the Internet, which is a network environment that is not the first computing environment 110, and is external to the first computing environment 110. In certain embodiments, an endpoint 120 is a software application, a virtual machine, a software container, a serverless function, combinations thereof, and the like.

In an embodiment, the computing environment 110 includes cloud entities such as resources, principals, and the like. According to an embodiment, a resource is a computing resource, such as a physical resource (e.g., memory, storage, processor, and the like), a virtual resource (e.g., a virtual machine, a software container, a serverless function, and the like), combinations thereof, and the like.

In certain embodiments, the computing environment 110 includes a serverless function 130, a virtual machine 140, a software container 150, combinations thereof, and the like. For example, in an embodiment, a software container 150 is deployed on the virtual machine 140. In some embodiments, a serverless function 130 is implemented as Amazon® Lambda, Google® Cloud Functions, and the like. A virtual machine 140, is implemented, according to an embodiment, as Oracle® VirtualBox®. In some embodiments, the software container 150 is implemented as a Kubernetes® platform, a Docker® Engine, and the like.

A cloud computing environment 110 is susceptible to cybersecurity risks, such as cybersecurity attacks exploiting exposures, misconfigurations, malware, and the like. In an embodiment, the cloud computing environment 110 is connected to an inspection environment 160. For example, according to an embodiment, the inspection environment 160 includes an inspection controller 175 which is configured to control a plurality of inspector workloads, such as inspector 190.

In an embodiment, an inspector 190 is configured to inspect a resource, such as the serverless function 130, for a cybersecurity object. In an embodiment, a cybersecurity object is a secret, a password, a certificate, a weak password, a sensitive data, a sensitive data indicator, a misconfiguration, an exposure, a vulnerability, an application identifier, an operating system identifier, a combination thereof, and the like.

In certain embodiments, the inspection controller 175 is configured to access a principal, such as a service account, of the cloud computing environment 110, generate an inspectable disk from a disk associated with a resource in the cloud computing environment 110, and provide access to the inspectable disk to the inspector 190. This is advantageous, according to an embodiment, in order to inspect the contents of a disk without disturbing a production environment.

A production environment is a computing environment which provides, for example, a service. Resources of a production environment are utilized in providing the service, therefore diverting a portion of those resources in order to perform inspection for cybersecurity objects is not desirable. By generating an inspectable disk and inspecting the same, the contents of the original disk remain unperturbed, allowing the production environment to remain operational, while still being able to inspect the contents of the disk in order to ascertain the presence of the cybersecurity object.

In certain embodiments, a security graph 170, stored on a graph database (such as, e.g., Neo4j)

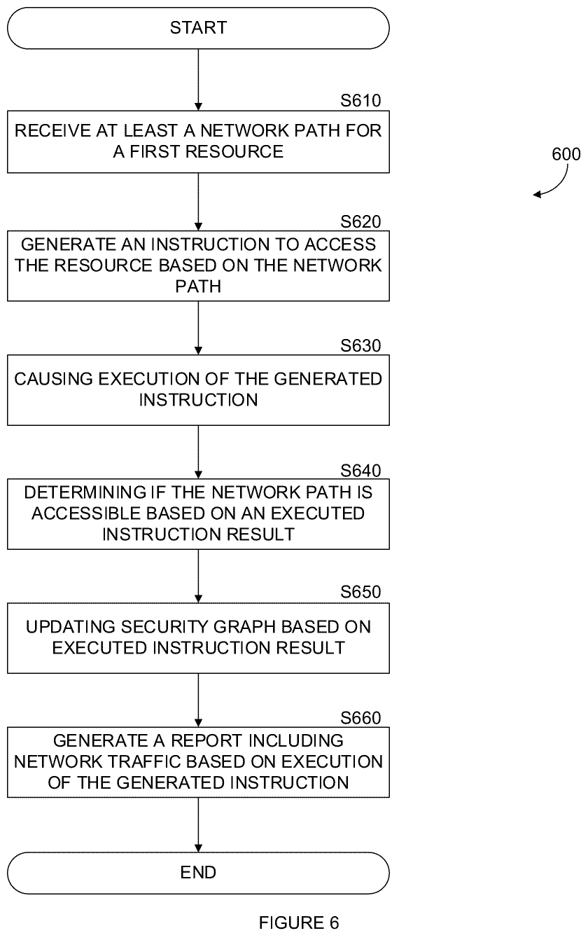

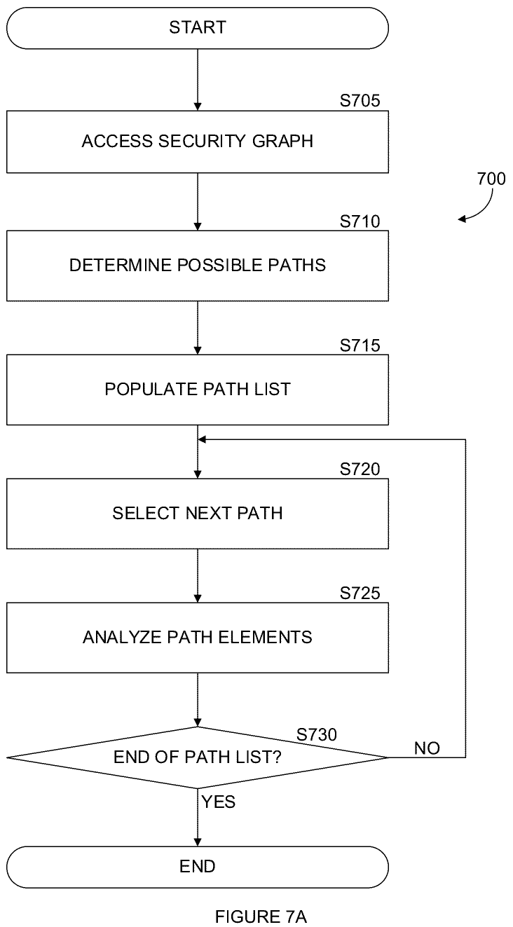

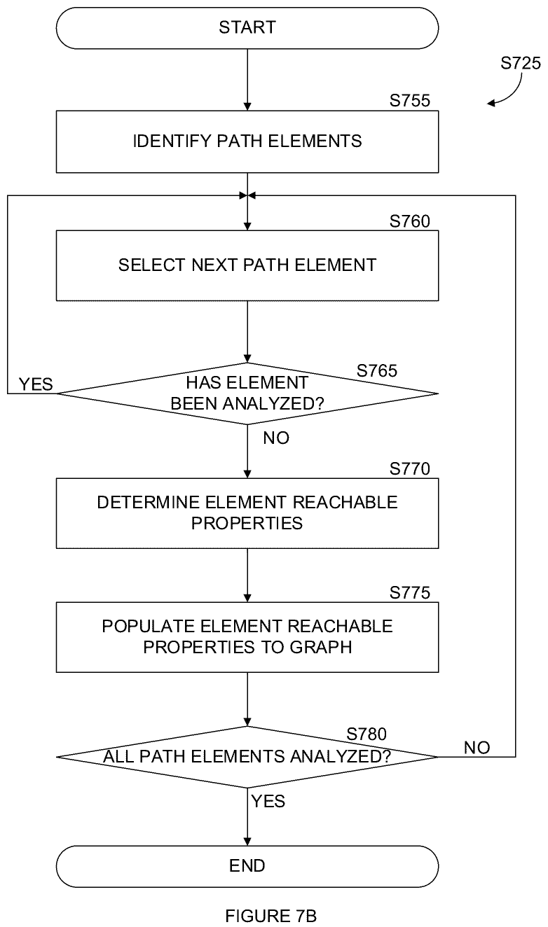

In some embodiments, the inspector 190 is configured to perform active inspection. Active inspection is discussed in more detail in FIG. 6, FIG. 7A, and FIG. 7B below. In some embodiments, active inspection includes accessing a resource, for example using hypertext transfer protocol (HTTP) commands to receive a response. In certain embodiments, the response includes a hypertext markup language (HTML) page, and further includes an image, a video, a text, a multimedia, a combination thereof, and the like.

In certain embodiments, it is advantageous to provide a user interface for displaying responses received from inspected resources. Visual mediums are generally accepted as being a convenient form of conveying information to humans. Examples of user interfaces are discussed in more detail below. In an embodiment, the inspection controller 175 is configured to generate instructions which, when rendered, configure a computing device to display the user interface.

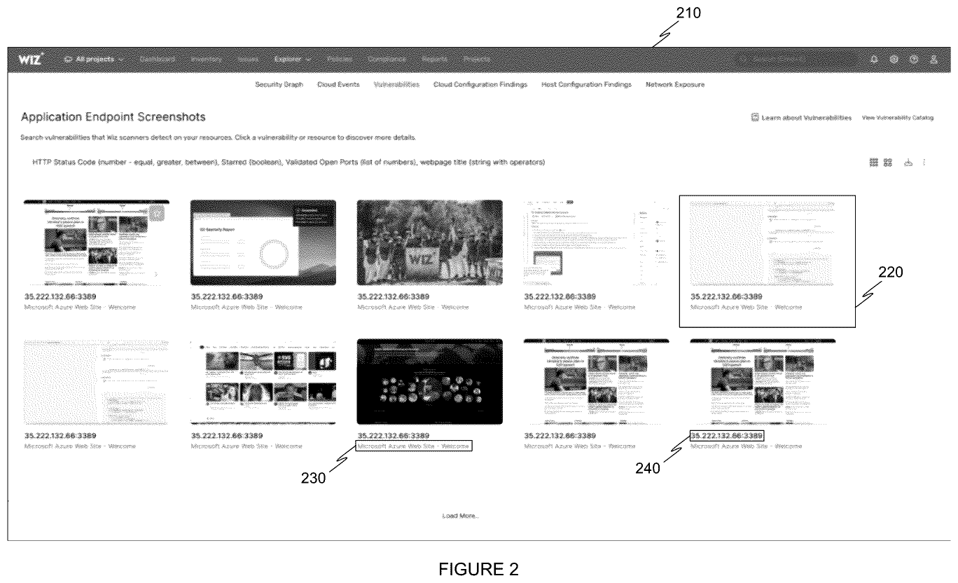

FIG. 2 is an example diagram of a user interface, utilized to describe an embodiment. In an embodiment, the user interface 210 includes a screenshot, a screen grab, and the like. In some embodiments, each screenshot is associated with a resource on which active inspection is performed. For example, in an embodiment, an inspector is configured to perform active inspection of an Nginx® web server application deployed on a virtual machine in a cloud computing environment.

In response to accessing the web server application, a response is received, according to an embodiment. In an embodiment, a display portion 220 is generated based on each received response. In some embodiments, the display portion is generated using, for example, an HTML frame. In certain embodiments, the display portion includes a screenshot, metadata, data, and the like. In an embodiment, the display portion further indicates a cybersecurity object, a cybersecurity vulnerability, a misconfiguration, and the like.

In certain embodiments, a display portion includes metadata, such as an HTML title tag 230. In some embodiments, metadata includes various HTML tags, such as title, header, body, and the like. In an embodiment, the display portion includes resource descriptors, such as network descriptor 240. In certain embodiments, the network descriptor 240 includes an IP address, a port, a username, a password, a combination thereof, and the like. In some embodiments, a resource descriptor is an application identifier, an application version identifier, an operating system identifier, an operating system version identifier, a resource type (e.g., serverless function, virtual machine, software container, and the like), a cloud computing infrastructure identifier, a combination thereof, and the like.

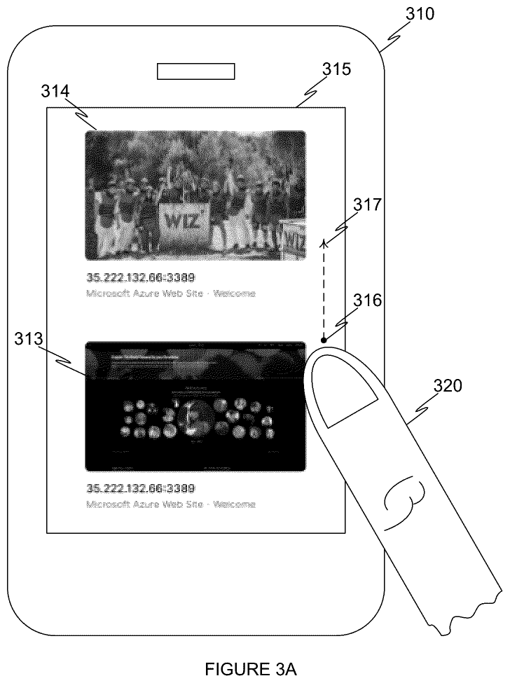

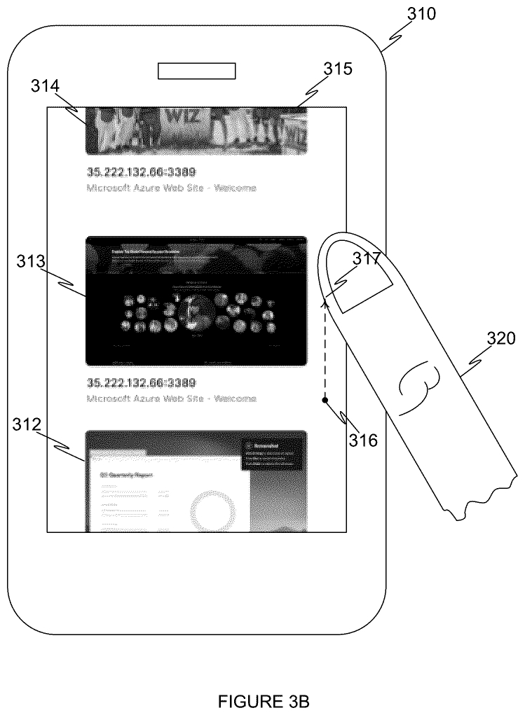

FIG. 3A is an example diagram of an electronic document for a user interface rendered on a user device, utilized to describe an embodiment. In an embodiment, the user interface includes generating an electronic document. An electronic document is, for example, an HTML page, an XML page, a JSON file, and the like. In some embodiments, the electronic document includes a text, a picture, a multimedia, combinations thereof, and the like.

In an embodiment, the electronic document includes a plurality of display portions, such as the display portion of FIG. 2 above. In some embodiments, a user device 310 is configured to render the electronic document on a display 315. In certain embodiments, the electronic documents include a plurality of display portions, each display portion corresponding to a result of an active inspection of a resource. In some embodiments a number of display portions exceeds a threshold, so that only a sub-group of the plurality of display portions is rendered on a display 315 of the user device 310.

For example, the display 315 is configured to render an image including a first display portion 314 and a second display portion 313, each corresponding to a respective result of an active inspection. In some embodiments, the user device 310 further includes an input device, such as a capacitive touchscreen, a resistive touchscreen, a key, a button, a combination thereof, and the like.

According to an embodiment, a user enters an input, for example by pressing on a touchscreen attached to the display 315 from a first point 316 to a second point 317. In an embodiment, in response to receiving the input, an updated electronic document is rendered for the display 315. An example of an updated electronic document rendering is discussed in more detail in FIG. 3B below.

FIG. 3B is an example diagram of another portion of an electronic document for a user interface rendered on a user device, utilized to describe an embodiment. In an embodiment, a user device 310 receives an input from a user, for example by a user's finger 320 touching a touchscreen of a display 315 at a first point 316, moving the finger 320 to a second point 317, and releasing the touch, resulting in an upward swipe.

According to an embodiment, in response to receiving the input from the user, an updated electronic document is rendered on the display 315. For example, according to an embodiment, a different portion of the electronic document is provided for rendering on the display 315. In some embodiments, the updated electronic document includes the second display portion 313, a part of the first display portion 314, and a part of a third display portion 312.

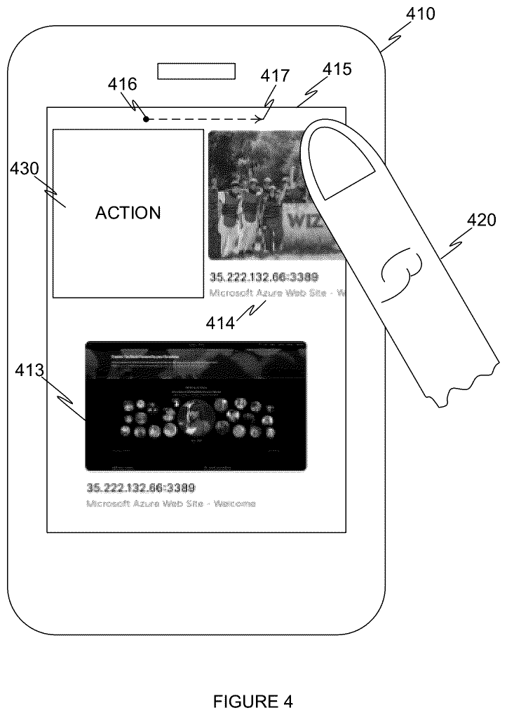

FIG. 4 is an example diagram of an electronic document for a user interface and action rendered on a user device, utilized to describe an embodiment. In certain embodiments, an action is associated with a display portion. In some embodiments, a plurality of actions are associated with a display portion. In some embodiments, an action associated with a display portion includes an instruction, which when executed, configures a system to perform a mitigation action. For example, in an embodiment, a mitigation action is associated with a cybersecurity vulnerability which is indicated in active inspection.

In some embodiments, an action includes an instruction which, when executed, generates an alert based on a cybersecurity object associated with the display portion. For example, in an embodiment, in response to receiving a user input associated with a first display portion 414, an electronic document is rendered to include a part of the first display portion 414, and an action button 430.

In an embodiment, a user input is received based on detecting a first input (e.g., a touch at first point 416), followed by a swipe performed by a human finger 420 towards a second point 417. In an embodiment, a length of the swipe (i.e., the distance between the first point 416 and second point 417) is utilized in determining an amount of display in the display 415 dedicated to each of the first display portion 414 and action button 430. In some embodiments, where the length of the swipe is less than a predetermined threshold, the action button 430 is shown for a predetermined period of time, without a user being able to interact with the action button 430.

In certain embodiments, for example where the length of the swipe exceeds a predetermined threshold, the action button 430 is rendered as part of the electronic document. In some embodiments, the action button 430 is associated with a computer instruction, such that when an input is received from a user based on the action button 430, the user device 410 instructs a system, such as the inspection controller 175 of FIG. 1 above, to perform an action, perform a set of actions, and the like, based on a display portion which is associated with the action.

For example, in an embodiment, the action associated with the action button 430 is generating a ticket in a ticket management system. In response to receiving a user input based on the first point 416 and the second point 417, the action button 430 is generated for display on the display 415.

In an embodiment, the user device 410 is configured to receive an input from a user, the input associated with the action button 430. For example, according to an embodiment, a touchscreen of the display 415 detects a human finger 420 touching the touchscreen at coordinates which are associated with where the action button 430 is rendered on the display 415.

In some embodiments, in response to detecting the input (e.g., the touch at a point which is associated with a display area of the display 415 where the action button 430 is rendered), the user device 410 is configured to send an instruction which initiates the action.

Providing such as user interface allows a user to interact with a report of cybersecurity issues detecting during active inspection in a manner which is natural to a human operator. This improved interaction is important where a user deals with hundreds or more of such results of active inspection of a cloud computing environment. The user interface disclosed herein renders a visual aid for a user, thus increasing the amount of information a user is able to consume, thereby also decreasing the response time to a real, or potential, cybersecurity threat.

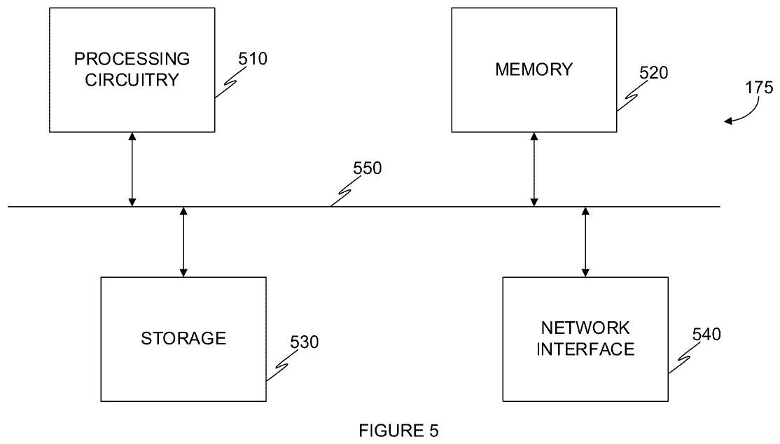

FIG. 5 is an example schematic diagram of an inspection controller 175 according to an embodiment. The inspection controller 175 includes a processing circuitry 510 coupled to a memory 520, a storage 530, and a network interface 540. In an embodiment, the components of the inspection controller 175 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof. In an embodiment, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein may be stored in the storage 530, in the memory 520, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 440 is configured to provide the inspection controller 175 with communication with, for example, the security graph 170, the active inspector 180, an inspector 190, and the like.

It should be understood that the embodiments described herein are not limited to the specific architecture illustrated in FIG. 5, and other architectures may be equally used without departing from the scope of the disclosed embodiments.

Furthermore, in certain embodiments the active inspector 180, the inspector 190, and the like, may be implemented with the architecture illustrated in FIG. 5. In other embodiments, other architectures may be equally used without departing from the scope of the disclosed embodiments.

FIG. 6 is an example flowchart 600 of a method for performing active inspection of a cloud computing environment, implemented in accordance with an embodiment.

At S610, at least one network path for a first resource in a cloud computing environment is received. The network path, also known as object reachability, includes data (e.g. reachability parameters) for accessing the first resource from a public network, which is not the cloud computing environment of the first resource, such as the Internet. In an embodiment, an active inspector may receive the at least a network path, for example from a security graph. In an embodiment, S610 includes generating an instruction (or instructions) which when executed by a database system storing the security graph return a result of one or more resources, and a respective network path for each of the one or more resources. In certain embodiments, the network paths may be received periodically.

In some embodiments, the first resource may be one of a plurality of first resources, which are each substantially identical. For example, a group of virtual machines which are generated based on the same code or image are substantially identical, since their initial deployment would be identical other than a unique identifier assigned to each machine. In such embodiments it may be beneficial to inspect the at least one network path for a subset of the plurality of first resources, in order to decrease the computation and network resources required. This may be acceptable in such embodiments, as the expectation is that the plurality of VMs would be accessible in similar network paths. In some embodiments, the subset includes one or more first resources.

In an embodiment, each of the received network paths includes a set of reachability parameters to reach a specific cloud object in the cloud environment. The reachability parameters, and hence the network paths are generated by statically analyzing the cloud environment. An example method for such static analysis is described with reference to FIGS. 7A and 7B below.

At S620, an access instruction is generated to access the first resource based on the network path. In an embodiment, the access instruction is generated by the active inspector deployed outside of the cloud environment where the first resource resides. In certain embodiments, the instruction includes one or more access parameters. Such parameters may include, but are not limited to, a host name, an IP address, a communication protocol, a port, a username, a password, and the like, or combination thereof. A communication protocol may be, for example, HTTP or UDP (user datagram protocol). For example, the instruction may be a ping, GET, CONNECT, or TRACE request over HTTP.

In certain embodiments, a plurality of access instructions may be generated. For example, a plurality of generated access instructions may include a first access instruction having a first request, and a second access instruction having a second request which is different from the first request. For example, the first access instruction may include a CONNECT request, and the second access instruction may include a GET request. In certain embodiments, a plurality of first access instructions may be generated. In such embodiments, each first access instruction may include a same type of request (e.g., CONNECT) with different values (e.g., different web address, different port, and so on). For example, a resource may be reachable at IP address 10.0.0.127, at ports 800 through 805. The IP address and ports would be reachability parameters, based on which an active inspector can generate a plurality of first access instructions based on an HTTP GET request, such as:
GET /bin HTTP/1.1
Host:10.0.0.127:800
   and further generate another HTTP GET request:
GET /bin HTTP/1.1
Host:10.0.0.127:801
   and so on, which when executed attempt to access a /bin folder in the resource which has an IP address of 10.0.0.127. In certain embodiments, the active inspector (e.g., the active inspector 180 of FIG. 1) may connect to a proxy server (not shown) through a public network (e.g., the Internet), and send a first access instruction to a resource in the cloud environment 110 through a first proxy server, and send a second access instruction (which may or may not be identical to the first access instruction) through a second proxy server. In such embodiments, each proxy server may show as originating from a different country of origin, therefore the source would receive access requests from seemingly different sources. This is advantageous to determine, for example, if a resource is configured to block certain network traffic based on geographic location.

At S630, execution of the generated access instruction is caused. The access instruction, when executed, causes an attempt to actually access the resource. In an embodiment, the attempt may result in network traffic being generated, including requests sent to the resource and answers (i.e., data packets) received. While static analysis provides a possible path to access a resource, executing the access instruction provides a real result of an attempt to utilize the possible path, in order to determine which paths are really viable, and which are not. For example, a path may be possible based on static analysis, but not viable, where, for example, an application deployed on the resource prevents such an access from occurring. In an embodiment a network path is determined to be viable (or accessible), if the access instruction, when executed does not return an error message. An error message may be, for example, a timeout (e.g., in response to a “ping” request), a 403 Forbidden (e.g., in response to an HTTP GET request), and the like. In some embodiments, the access instruction may be executed by the active inspector 180.

At S640, a determination is performed to determine if the network path is accessible, based on the execution of the generated access instruction. Performing an active inspection of a cloud environment allows to determine which of the reachability paths (i.e., network paths) are indeed vulnerable, meaning that paths that can be used to gain access into the cloud environment, and which reachability paths (network paths) are not vulnerabilities since the active inspector could not gain access to the resource, therefore the reachability path is not possible in practice. Reachability paths which have been confirmed through both static analysis (i.e., analysis using the security graph) and active inspection are paths which should therefore be considered more vulnerable. In an embodiment, if the network path results in successfully reaching the resource, the network path is determined to be accessible (or viable). If the resource is not reachable by the network path, the network path is determined to be inaccessible (or unviable).

At S650, a security graph is updated based on the network path determination. In certain embodiments, the active inspector may update the security graph, which includes a representation of the cloud environment in which the first resource is deployed, to indicate whether a reachability path is confirmed (i.e., is viable) by active inspection or not, where a confirmed path is a path through which the active inspector successfully accessed a resource. In turn, the security graph may update an alert generated based on determining that a resource has a reachability path through a public network.

At S660, a report is generated based on the execution of the generated instruction. In an embodiment, the report may be generated by the active inspector, which performs this method. In certain embodiments, generating a report may include updating a log with network traffic between the active inspector and the resource. For example, the active inspector may record (e.g., write to a log) the generated instruction, the resource identifier, and a response received from the resource. A response may include, for example, a response code. A response code may indicate success, redirection, client error, server error, and the like, where the client is the active inspector, and the server is the resource. In certain embodiments the security graph 170 stored in the graph database is updated based on the determined viability of the network paths. For example, if a resource is successfully accessed, or successfully unaccessed (i.e., an attempt was made to access the resource and the attempt was not successful in accessing the resource), this result can be stored as an attribute of a node representing the resource in the security graph.

For example, in an embodiment, a node representing a resource in the security graph includes an attribute which indicates a reachability status, which may have values corresponding to: successfully reached (i.e., an active inspector successfully accessed this resource), successfully not reach (i.e., an active inspector was not successful in accessing this resource), and undetermined (the active inspector has not yet attempted to access the resource through a network path). In some embodiments, certain network paths may be determined (i.e., as viable or unviable) while others may be undetermined. A node may be associated with a plurality of network paths, each having its own active inspection indicator.

In some embodiments, the active inspector is configured to communicate with a virtual private network (VPN) or a proxy, in order to mask the IP address from which the active inspector is attempting access. This may be useful to test, for example, if a firewall will let communication through based on blocking or allowing certain IP addresses. In such embodiments, multiple similar instructions may be generated, each originating from a different IP address of the active inspector.

In some embodiments, a network path includes a plurality of resources. The method above may be performed on each resource of the plurality of resources, to determine the reachability of each resource.

Utilizing an active inspector using network paths generated from a security graph is advantageous, as attempting to access resources in this manner to determine the viability of a network path (i.e., reachability) requires less resources than, for example, randomly guessing network paths in an attempt to access resources.

In certain embodiments the active inspector is configured to generate a screenshot, screengrab, and the like, of a user interface used to access the resource through the network path. For example, in an embodiment an active inspector includes a Chromium® based web browser which is configured to render a web page based on a response received from a resource during active inspection. In some embodiments, the web browser is further configured to generate a screenshot, which is then utilized in rendering a display portion, such as described in more detail in FIG. 2 above.

In an embodiment, utilizing the active inspector to validate network paths and updating a security graph with the results allows to detect workloads which both contain a vulnerability, and have a validated network path. This allows generating an alert to a user of the cloud computing environment in order to address such problems by accurately characterizing cybersecurity threats. This in turn allows to utilize resources more efficiently, since the most vulnerable gaps in the cloud environment will be addressed first.

FIG. 7A is an example flowchart 700 depicting a method for determining reachable properties of security objects, according to an embodiment. A reachable property defines if and how an object on the generated security graph can be reached from an external or internal network, and/or an external or internal object. External means outside of the cloud environment of an organization. An object may be any computing or network object designated in a security graph generated as discussed above.

At S705, a security graph is accessed or otherwise obtained from the graph database. Within a security graph, various objects or entities, as may be included in a network or cloud environment of an organization, may be represented as “nodes” or “vertices,” and such “nodes” or “vertices” may be interconnected by one or more “links” or “edges,” the “links” or “edges” representing the relationships between the various objects included in a network or environment. Each object in the graph may be associated with known properties of the object. Examples for such properties may include an object's name, its IP address, various predefined security rules or access rules, and the like.

At S710, possible network paths within the obtained security graph are identified. A network path is a connection of two or more security objects accessible from an external or internal network, and/or an external or internal object. That is, a network path may include sequential representations of possible data/control flows between two or more objects in a graph. In an embodiment, where two objects in a graph are represented as vertices, and where the vertices are joined by an edge, a path may be constructed between the two vertices. A path may be a vertex-only path, describing a sequence of vertex-to-vertex “hops,” an edge-only path, describing only the edges included in the sequence without description of the associated vertices, or a combined edge-vertex path, describing both edges and vertexes included in the sequence.

According to disclosed embodiments, a path shows a connection between security objects and/or computing objects that communicate over a network. An object may be a virtual, physical, or logical entity.

In an embodiment, paths can be identified by traversing the security graph. The traversal can start or end at objects that are connected to an external network (the internet). The traversal of the security graph can be performed using solutions disclosed in the related art, e.g., a breadth-first search (BFS), a tree traversal, and the like, as well as any combination thereof.

In another embodiment, paths can be identified by querying the graph database storing the security graph. Examples of applicable queries include, without limitation, queries configured to identify all paths between a first graph object (node) and a second graph object, queries configured to identify all paths between all graph vertices of a first object type and all graph vertices of a second object type, other, like, queries, and any combination thereof.

Following as performed at S710 through S730, the list of paths are iteratively identified to determine the reachability properties of the path. Specifically, at S715, a path list is populated to include all identified paths. A path list may be a table, list, or other type of data structure. A path list may be unordered or ordered, including ordering according to one or more path properties.

At S720, a path from the path list is selected. At a first run of the method a first path in the list is selected.

At S725, path elements are analyzed to determine reachable properties. Path element analysis, as at S725, is an iterative analysis of each element included in the path selected at S720. The operation of S725 is discussed in detail with reference to FIG. 7B.

At S730, it is determined whether the last path of the path list has been analyzed, and if so, execution terminates; otherwise, execution returns to S720.

FIG. 7B is an example flowchart S725 depicting the analysis of a network path to determine reachable properties of objects included in the path, according to an embodiment.

At S755, elements within a selected network path are identified. Elements are network and/or computing objects and relationships (or connections) between such objects. Identification of elements within the selected path may include, without limitation, identification based on properties, and other, like, data, included in the elements, identification of elements based on element identifications provided during the execution of S710 of FIG. 7A, above, and the like, as well as any combination thereof. Further, identification of in-path elements may include identification of element properties or attributes including, without limitation, names, network addresses, rulesets, port configurations, and the like, as well as any combination thereof.

Then, at S760 through S780, the list of paths are iteratively processed in order to determine reachable properties of the elements. Specifically, at S760, the next element is selected. The next element is a subsequent element of the set of elements, within the selected path, identified at S755. Where execution of S760 follows the execution of S780, the next element may be an element which, in the selected network path, immediately follows the element relevant to the preceding execution of S770 and S775. Where execution of the method described with respect to FIG. 7B includes a first execution of S760, the first execution of S760 may include the selection of a first element of the selected path.

As an example according to an embodiment, a network path may be a path from a virtual machine (VM), connected to a NIC, connected to a load balancer, connected to a firewall. According to a first example, where S760 is executed for the first time, the first execution of S760 may include the selection of the VM as the selected element. Further, according to a second example, where execution of S760 follows execution of S780, selection of a next element at S760 may include selection of, following the VM, selection of the NIC, or, following the NIC, selection of the load balancer, or, following the load balancer, selection of the firewall.

At S765, it is determined whether the selected element has been analyzed. Determination of whether the selected element may include the determination of whether one or more reachable properties are included in the relevant graph element. As execution of S775 provides for the population of reachable properties into the security graph, an element which does not include such reachable properties in the graph may be assumed to have not been analyzed.

Where, at S765, it is determined that the selected element has been analyzed, execution continues with S760. Where, at S765, it is determined that the selected element has not been analyzed, execution continues with S770.

At S770, reachable properties are determined. Reachable properties are object properties describing if, and how, a given path element is reachable through the selected path, and, specifically, from an external network, an internal network, both, and a combination thereof. Examples of reachable properties include, without limitation, binary properties describing whether an element is reachable, protocols by which the element is reachable, network addresses at which an element is reachable, ports by which an element is reachable, access rules, and the like, as well as any combination thereof.

In an embodiment, a reachable property is determined as a minimal set of reachable properties of all other objects in the path. As a simple example, if a path includes two objects, where one object can receive traffic from any source IP address through port 1515, and the other object can receive traffic only from a source IP address of 173.54.189.188, the reachable property of the second object may be that the second object is reachable through “source IP address 173.54.189.188 and port 1515.”

At S775, reachable properties are populated into the security graph. Reachable properties, as may be determined at S770, may be populated into the graph by processes including, without limitation, labeling or tagging graph vertices (or “nodes”), updating network or graph object properties, generating one or more graph overviews, layers, or graph-adjacent data features, and the like, as well as any combination thereof.

In an embodiment, population of reachable properties into the security graph may include, for each object, population of object network access control lists (NACLs) as described hereinbelow, into the security graph elements corresponding with the various path elements, as well as the population of scope specific NACLs, and other, like, properties into the graph. Scope-specific NACLs are NACLs describing object, path, or network accessibility properties specific to a given scope, where a given scope may be the internet, various given accounts, various given environments, and the like. Scope-specific NACLs may, for example, describe the properties of an object with respect to the object's internet accessibility, where the object may be configured to include different access control properties for internet access and local intranet access.

Further, population of reachable properties into the graph may include population of one or more paths into the graph, including by population processes similar or identical to those described with respect to population of individual objects. Population of paths into the graph may include, without limitation, population of one or more paths into the graph, including a presently-analyzed path, population of one or more path properties, and the like, as well as any combination thereof. Path properties, as may be populated to a graph, are properties describing various attributes of a path, including, without limitation, NACLs applicable to path elements, path segments, or full paths, including full-path aggregate NACLs, and the like, as well as any combination thereof. Further, population of path properties into the graph may include the population of one or more scope-specific path properties, where such scope-specific path properties may be properties relevant to specific scopes, such as those described herein.

Where population of reachable properties includes labeling or tagging a graph, or elements thereof, one or more graph vertices or edges, the corresponding objects or relationships, or both, may be labeled, tagged, or otherwise associated with one or more data features describing relevant reachable properties. In addition, where population of reachable properties to the graph includes updating graph objects, graph vertices and edges, the corresponding objects and relationships, or both, may be directly updated to explicitly include the calculated properties.

Further, where population of reachable properties includes the generation of one or more graph layers or overlays, the generated graph layers or overlays may be data features independent of, but corresponding to, the relevant graphs, where the generated overlays or layers may include one or more data features describing the reachable properties of the various graph elements.

At S780, it is determined whether all elements in the selected path have been analyzed. Determination of whether all elements in the selected path have been analyzed may include, without limitation, determination of whether the immediately preceding execution of S775 relates to the last element in the selected path, determination of whether additional elements remain in the path, determination of whether any additional in-path elements have been analyzed, and the like, as well as any combination thereof.

Where, at S780, it is determined that all elements in the selected path have not been analyzed, execution continues with S760. Where, at S780, it is determined that all elements in the selected path have been analyzed, execution terminates.

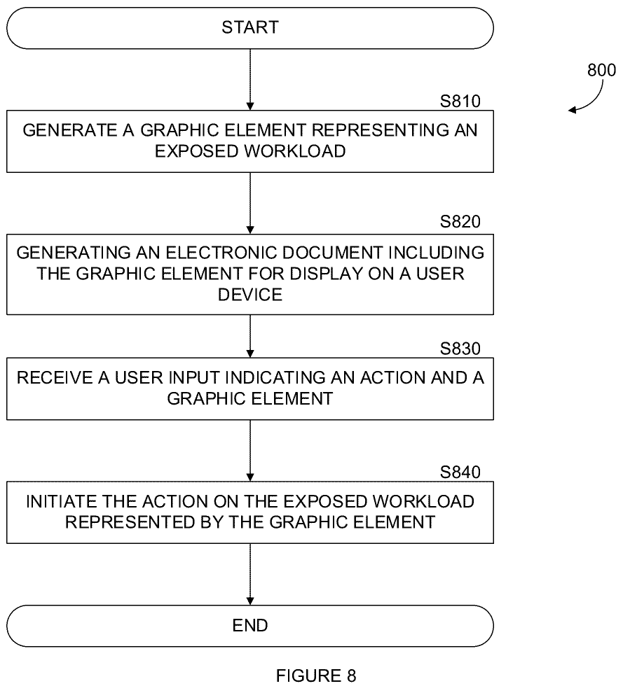

FIG. 8 is a flowchart of a method for rendering a graphical user interface (GUI) for a user device based on a plurality of active inspection results, implemented in accordance with an embodiment.

At S810, a graphic element representing an exposed workload is generated. In an embodiment, the graphic element is part of an electronic document including a plurality of parts, each part (also referred to as a display portion) corresponding to a respective result of an active inspection of a resource in a cloud computing environment. In some embodiments, the graphic element includes a screenshot generated from a response generated from active inspection of a resource.

In certain embodiments, the graphic element further includes metadata, such as HTML tags, such as title, header, body, and the like. In an embodiment, the graphic element includes resource descriptors, such as a network descriptor. In certain embodiments, the network descriptor includes an IP address, a port, a username, a password, a combination thereof, and the like.

In some embodiments, a resource descriptor is an application identifier, an application version identifier, an operating system identifier, an operating system version identifier, a resource type (e.g., serverless function, virtual machine, software container, and the like), a cloud computing infrastructure identifier, a combination thereof, and the like.

At S820, an electronic document is generated. In an embodiment, the electronic document includes a plurality of graphic elements. In some embodiments, the electronic document includes an order in which the graphic elements are rendered, such that a first graphic element is rendered before a second graphic element. In certain embodiments, each graphic element is rendered based on a fixed size, such as a fixed width, fixed length, a combination thereof, and the like. In an embodiment, a display size is received. For example, a display size in pixels, including a number of pixels wide by a number of pixels high, is received.

In certain embodiments, a number of graphic elements is determined based on the display size, a fixed size of the graphic element, a combination thereof, and the like, such that when rendered for display a whole number of graphic elements is rendered for display. In certain embodiments, a first graphic element is rendered as a whole, and a portion of a second graphic element is rendered, while a remaining portion of the second graphic element is not rendered.

At S830, a user input is received. In an embodiment, the user input is received based on an interaction with a display. For example, in an embodiment, a user provides an input by touching a touchscreen coupled with the display on which the graphic element is rendered. In some embodiments, an action graphic is rendered in proximity to the graphic element, such that the action is performed on a resource represented by the graphic element.

For example, in an embodiment, an action graphic is rendered in response to receiving a first user input based on a first graphic element. For example, the first user input is, in an embodiment, a touch input on a display portion in which the first graphic element is rendered. In some embodiments, the touch input indicates a detected motion, such as a swipe motion (i.e., moving a finger from one part of the touchscreen to another part of the touchscreen).

In an embodiment, a plurality of action graphics are rendered, each action graphic representing an action which can be performed on a resource represented by the first graphic element. In some embodiments, the action graphic represents a mitigation action. For example, the mitigation action is, in an embodiment, generating an alert, generating an alert severity, updating an alert severity from a first value to a second value, revoking network access to the resource, revoking network access from the resource, revoking service account access associated with the resource, combinations thereof, and the like.

In certain embodiments, a second user input is received, to indicate that the action should be initiated. For example, in an embodiment a second user input includes receiving another input from the touchscreen, at a display portion on which the action graphic is rendered. In some embodiments, receiving the second input (e.g., detecting a second touchscreen input at a predetermined area) configures a computing device displaying the graphic elements to initiate the action.

At S840, the action is initiated. In an embodiment, a plurality of graphical elements, each corresponding to a resource actively inspected, are rendered for display on a display of a user device. In certain embodiments, the user device is configured to receive an input which indicates that an action should be initiated. In response to receiving the input, detecting the input, combinations thereof, and the like, the user device is configured, in some embodiments, to initiate the action, for example by generating an instruction which when executed configures a system to initiate the action. For example, in an embodiment, in response to receiving an input, a user device is configured to generate an instruction for a ticket management system, which, when executed by the ticket management system, configures the system to generate a ticket based on the resource which is associated with the graphic element which is associated with the action.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for initiating a mitigation action based on active inspection of a cloud computing environment, comprising:
receiving at least one network path to access a resource, wherein the resource is a cloud entity deployed in the cloud computing environment, and potentially accessible from a network which is external to the cloud computing environment;
actively inspecting the at least one network path to determine if the resource is accessible through the at least one network path from a network external to the cloud computing environment;
generating a graphic element based on receiving a response from the resource of the active inspection of the at least one network path;
generating an action graphic element associated with the response;
rendering the graphic element and the action graphic element on a display; and
initiating a mitigation action based on the response, in response to receiving an input based on the rendered action graphic element.

2. The method of claim 1, further comprising:
generating an electronic document including a plurality of graphic elements, each graphic element corresponding to an active inspection performed on a unique network path.

3. The method of claim 2, further comprising:
rendering a first portion of the electronic document based on a size of the display.

4. The method of claim 3, further comprising:
rendering a second portion of the electronic document in response to receiving a request to render the second portion.

5. The method of claim 4, wherein the first portion of the electronic document includes a first graphic element which is not included in the second portion of the electronic document.

6. The method of claim 1, further comprising:
generating the action graphic element further in response to receiving a user input indicating a selection of the graphic element.

7. The method of claim 1, further comprising:
generating the graphic element to include any one of: a resource descriptor, a network descriptor, and a combination thereof.

8. The method of claim 1, further comprising:
generating the mitigation action to include any one of: generating an alert, generating an alert severity, updating an alert severity from a first value to a second value, revoking network access to the resource, revoking network access from the resource, revoking service account access associated with the resource, and any combination thereof.

9. The method of claim 1, further comprising:
rendering a plurality of action graphic elements, each corresponding to the response from the resource of the active inspection of the at least one network path.

10. A non-transitory computer readable medium having stored thereon instructions for causing a processing circuitry to execute a process, the process comprising:
receiving at least one network path to access a resource, wherein the resource is a cloud entity deployed in the cloud computing environment, and potentially accessible from a network which is external to the cloud computing environment;
actively inspecting the at least one network path to determine if the resource is accessible through the at least one network path from a network external to the cloud computing environment;
generating a graphic element based on receiving a response from the resource of the active inspection of the at least one network path;
generating an action graphic element associated with the response;
rendering the graphic element and the action graphic element on a display; and
initiating a mitigation action based on the response, in response to receiving an input based on the rendered action graphic element.

11. A system for initiating a mitigation action based on active inspection of a cloud computing environment, comprising:
a processing circuitry; and
a memory, the memory containing instructions that, when executed by the processing circuitry, configure the system to:
receive at least one network path to access a resource, wherein the resource is a cloud entity deployed in the cloud computing environment, and potentially accessible from a network which is external to the cloud computing environment;
actively inspect the at least one network path to determine if the resource is accessible through the at least one network path from a network external to the cloud computing environment;
generate a graphic element based on receiving a response from the resource of the active inspection of the at least one network path;
generate an action graphic element associated with the response;
render the graphic element and the action graphic element on a display; and
initiate a mitigation action based on the response, in response to receiving an input based on the rendered action graphic element.

12. The system of claim 11, wherein the memory contains further instructions which, when executed by the processing circuitry, further configure the system to:
generate an electronic document including a plurality of graphic elements, each graphic element corresponding to an active inspection performed on a unique network path.

13. The system of claim 12, wherein the memory contains further instructions which, when executed by the processing circuitry, further configure the system to:
render a first portion of the electronic document based on a size of the display.

14. The system of claim 13, wherein the memory contains further instructions which, when executed by the processing circuitry, further configure the system to:
render a second portion of the electronic document in response to receiving a request to render the second portion.

15. The system of claim 14, wherein the first portion of the electronic document includes a first graphic element which is not included in the second portion of the electronic document.

16. The system of claim 11, wherein the memory contains further instructions which, when executed by the processing circuitry, further configure the system to:
generate the action graphic element further in response to receiving a user input indicating a selection of the graphic element.

17. The system of claim 11, wherein the memory contains further instructions which, when executed by the processing circuitry, further configure the system to:
generate the graphic element to include any one of: a resource descriptor, a network descriptor, and a combination thereof.

18. The system of claim 11, wherein the memory contains further instructions which, when executed by the processing circuitry, further configure the system to:
generate the mitigation action to include any one of: generating an alert, generating an alert severity, updating an alert severity from a first value to a second value, revoking network access to the resource, revoking network access from the resource, revoking service account access associated with the resource, and any combination thereof.

19. The system of claim 11, wherein the memory contains further instructions which, when executed by the processing circuitry, further configure the system to:
render a plurality of action graphic elements, each corresponding to the response from the resource of the active inspection of the at least one network path.
